(19) United States
(12) Patent Application Publication
(10) Pub. No.: US 2026/0009488 A1
(43) Pub. Date: Jan. 8, 2026

(54) COATING MATERIAL STRUCTURE

(71) Applicant: ZHI HUI CO., LTD., Taoyuan City (TW)

(72) Inventor: Chung Hsiao Huang, Taoyuan City (TW)

(21) Appl. No.: 18/764,243

(22) Filed: Jul. 4, 2024

(51) Int. Cl. F16L 53/34; B32B 1/08; B32B 5/18; B32B 7/12; B32B 9/04; B32B 27/28; F16L 59/02

(52) U.S. Cl. CPC F16L 53/34; B32B 1/08; B32B 5/18; B32B 7/12; B32B 9/045; B32B 27/281; F16L 59/029; B32B 2266/057; B32B 2307/304

(57) ABSTRACT

The invention provides a coating material structure, including a packaging main body; and the packaging main body includes: a heater, an inner layer and an outer layer, wherein the heater is arranged inside the packaging main body to heat a pipeline; the inner layer is arranged between the pipeline and the heater, which has an inner flame-resistant layer; and the outer layer is arranged on outer surface of the heater for heat preservation and improves the working efficiency of the heater. By sandwiching the heater with the inner layer and the outer layer, the generated particles will not escape into the environment when the heater causes the insulating layer cracks or volatiles appear, thereby reducing environment dust. Moreover, the inner flame-resistant layer does not produce particles and volatiles when below the operating temperature. The inner flame-resistant layer can also be directly used as an insulating layer.

### BACKGROUND OF THE INVENTION

### 1. Field of the Invention

The present invention relates generally to a heating system of gas pipelines, and more particularly, to a coating material structure able to avoid the volatilization of coating materials and cover dust sources to reduce the amount of dust in the environment.

### 2. The Prior Arts

Various chemical gases are often used in the semiconductor manufacturing process, and these gases are heated to 300 to 500 degrees Celsius for use in the manufacturing process. The used exhaust gas is extracted through the gas pipeline and sent to the exhaust gas purification facility or filtration system. The high-temperature waste gas after use may be mixed with different chemicals or another gas formed by chemical reactions. Once exposed to pipelines at room temperature, the exhaust gas itself or the chemicals in it will crystallize on the inner wall of the pipe, gradually blocking the gas pipeline, resulting in reduced pipeline efficiency and increased maintenance frequency.

In order to avoid crystallization on the inner wall of the pipe, the most commonly used solution is to use a pipeline heating system, commonly known as a Heating Jacket System, to heat the gas pipeline to prevent exhaust gas from condensation or crystallization by contacting the room-temperature pipeline. However, in order to increase the yield in the semiconductor manufacturing process, manufacturing needs to be carried out in a clean room, and the amount of dust in the space must be strictly controlled. The structure of the conventional jacket heater is that the outermost insulation layer covers the heater and the pipeline, and the heater is provided with an insulation layer to prevent leakage. If the insulation layer is used in a high-temperature environment in contact with the heater for a long time, it will decompose or produce volatile matter, becoming the main source of dust in the clean room, affecting the cleanliness of the clean room and thus affecting the product yield.

In view of the shortcomings of the conventional pipeline heating system, as long-term contact with the heater in a high-temperature environment will cause the insulating layer of the heater to crack or produce volatile matter, thereby generating a large amount of dust particles and escaping into the environment, causing damage to the cleanliness in clean rooms, it is imperative to develop solutions that can address the above problems.

### SUMMARY OF THE INVENTION

A primary objective of the present invention is to provide a coating material structure that can be used in pipeline heating systems and has a flexible soft material to seal and cover the heater to reduce the amount of dust in the environment.

Another objective of the present invention is to provide a coating material structure using a soft material that is resistant to high temperatures and will not decompose or volatilize to produce a large amount of particles during long-term use.

In order to achieve the aforementioned objectives, the present invention provides a coating material structure, which has a packaging main body, and the packaging main body includes: a heater, an inner layer and an outer layer. Wherein, the heater is arranged inside the packaging main body of the packaging material to heat the heating target; the inner layer is arranged between the heater and the target, covering the inner surface of one side of the heater; and the outer layer covers outer surface of the other side of the heater to enhance the heating effect of the heater. In the present invention, the inner side refers to the side of the flame-resistant layer that is close to the target to be heated during use, and the outer side refers to the outer layer that is far away from the target to be heated.

Wherein, the inner layer includes: an inner flame-resistant layer and an inner insulating layer, and the inner insulating layer covers the inner surface of the heater; the outer layer has an outer insulating layer, a thermal insulating layer, a glue layer and an outer skin; the outer insulating layer covers the heater; the thermal insulating layer covers the outer insulating layer for thermal insulating; the outer skin is arranged on the outermost side of the outer layer to prevent external substances from rubbing, puncturing or eroding the coating material structure of the present invention; the glue layer connects the outer skin and the insulation layer to avoid delamination; when power is turned on, the heater generates eddy current in the heating target to heat up the heating target, and the inner insulating layer and the outer insulating layer are used to prevent heater leakage.

Preferably, the inner insulating layer is covered by the inner flame-resistant layer; the outer insulating layer is arranged at the innermost side of the outer layer; and the inner flame-resistant layer does not produce a large amount of volatile matter when operating below the operating temperature so as to prevent the volatile matter generated by the heater from escaping to the outside environment to achieve the effect of reducing the amount of dust in the environment.

Preferably, the outer layer also has an outer flame-resistant layer, and both the inner flame-resistant layer and the outer flame-resistant layer have insulating properties and can be used as an insulating layer to cover the heater to prevent the insulating layer from producing a large amount of volatile matter when heated.

Preferably, the operating temperature of the outer insulating layer and the thermal insulating layer is between 160 and 260 degrees Celsius.

Preferably, the outer insulating layer and the thermal insulating layer can be foamed silicone.

Preferably, the operating temperature of the inner flame-resistant layer and the outer flame-resistant layer is between 150 and 300 degrees Celsius, and preferably 200 degrees Celsius. When used within the operating temperature range, the inner flame-resistant layer and the outer flame-resistant layer will not produce volatile matter.

Preferably, the inner flame-resistant layer and the outer flame-resistant layer are made of flame-resistant insulating soft materials, such as polyimide (PI).

Preferably, the packaging main body is formed into a tubular shape.

Preferably, the heater has a coil and can heat the target through induction heating.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating a correlation between components of a direction control apparatus according to an embodiment of the present invention;

FIG. 1 is a schematic structural view of an embodiment of the present invention;

FIG. 2 is a schematic detailed structural view of the first embodiment of the present invention; and

FIG. 3 is a schematic detailed structural view of the second embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

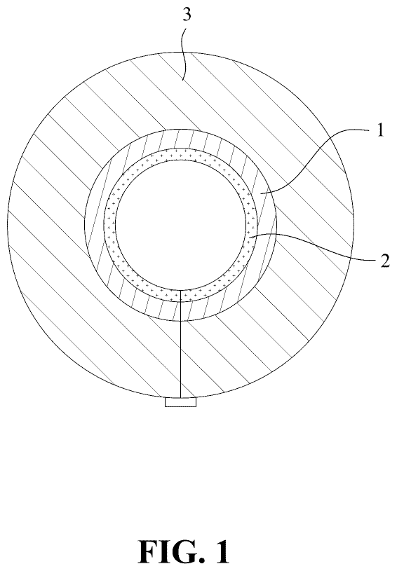

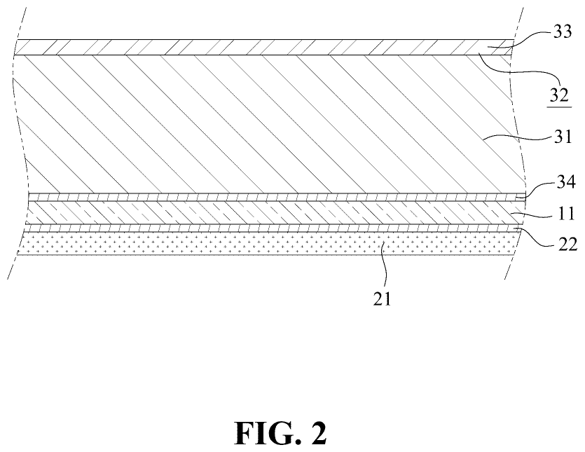

FIGS. 1 and 2 are schematic views of embodiments of the present invention. As shown in the schematic structural view of the present invention in FIG. 1 and the detailed structural view of the first embodiment of the present invention in FIG. 2, the coating material structure of the present invention has a packaging main body, which covers the gas pipeline and includes: a heater 1, an inner layer 2 and an outer layer 3. Wherein, the inner layer 2 has an inner flame-resistant layer 21 and an inner insulating layer 22; the outer layer 3 has an insulation layer 31, a glue layer 32, an outer skin 33 and an outer insulating layer 34, and the outer insulating layer 34 covers the heater 1. The thermal insulating layer 31 covers the outer insulating layer 34 for thermal insulating; the outer skin 33 is provided on the outermost side of the outer layer 3 to prevent external substances from rubbing, puncturing or eroding the coating material structure of the present invention; the glue layer 32 connects the outer skin 33 and the thermal insulating layer 31 to prevent delamination. The inner insulating layer 12 and the outer insulating layer 34 cover the inner surface and the outer surface of the heater 1. The inner surface refers to the side facing the covered gas pipeline, and the outer surface refers to the side opposite to the inner surface.

Preferably, the packaging main body covers the gas pipeline, and the heater 1 is started to heat the gas pipeline. The outer layer 3 prevents the heat generated by the heater 1 from escaping to the external environment through the insulation layer 31; the high resistance of the inner insulating layer 22 and the outer insulating layer 34 is used to prevent electricity leakage of the heater 1 from being conducted to the outside environment and causing harm as well as reduce the aging speed of the heater 1; the inner flame-resistant layer 21 covers the inner insulating layer 22; the outer insulating layer 34 is arranged on the innermost side of the outer layer 3 to prevent the inner insulating layer 22 and the outer insulating layer 34 from cracking due to high temperature or generating volatile matter during long-term use, resulting in the generated particles escaping into the external environment to increase the amount of dust in the environment, thereby reducing the amount of dust generated by the coating material structure of the present invention.

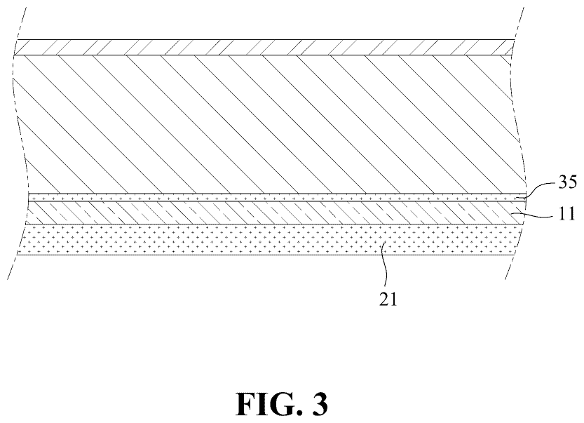

As shown in the detailed structural view of the second embodiment of the present invention in FIG. 3, the outer layer 1 also has an outer flame-resistant layer 35. Both the inner flame-resistant layer 21 and the outer flame-resistant layer 35 have insulating properties and can be directly used as an inner insulating layer 22 and an outer insulating layer 34 respectively, and the inner flame-resistant layer 21 and the outer flame-resistant layer 35 cover the heater 1.

Specifically, the heater 1 can be wrapped around and covered by the structure of the inner layer 2 and the outer layer 3, so that the particles and volatile matter generated by the heater 1 will not escape to the external environment. Moreover, when the inner flame-resistant layer 22 and the outer flame-resistant layer 35 operate below the operating temperature, they will not produce a large amount of particles and volatile matter, thus reducing the amount of dust in the environment.

Preferably, the operating temperature of the thermal insulating layer 31, the glue layer 32, the outer skin 33 and the outer insulating layer 34 can be 160-260 degrees Celsius.

Preferably, the thermal insulating layer 31 and the outer insulating layer 34 can be foamed silicone.

Preferably, the operating temperature of the inner flame-resistant layer 21 and the outer flame-resistant layer 35 can be 150-300 degrees Celsius, and preferably 200 degrees Celsius.

Preferably, the inner flame-resistant layer 21 and the outer flame-resistant layer 35 can be polyimide.

Depending on the length difference of the gas pipeline, the packaging material body can be designed into various shapes; for example, when the gas pipeline is long, an opening can be formed in the packaging material body to cover the gas pipeline, and when the gas pipeline is shorter, the packaging main body can be directly formed into a tubular shape.

In a preferred embodiment of the present invention, the heater has a coil 11, which can heat the gas pipeline through induction heating.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A coating material structure, having a packaging main body, further comprising:
a heater, disposed inside the packaging main body;
an inner layer, covering an inner side of the heater, and having an inner flame-resistant layer; and
an outer layer, covering an inner side of the heater:
wherein the inner flame-resistant able to operate within the temperature range of 150-300 degrees Celsius without producing volatile matter.

2. The coating material structure according to claim 1, wherein the inner layer further comprises an inner insulting layer, disposed between the inner flame-resistant layer and the heater.

3. The coating material structure according to claim 2, wherein the outer layer further comprises: an outer insulting layer, a thermal insulating layer, a glue layer, and an outer skin, the outer insulating layer covers the heater, the thermal insulting layer covers the outer side of the outer insulating layer, and the glue layer connects the thermal insulating layer and the outer skin.

4. The coating material structure according to claim 1, wherein the outer layer comprises an outer flame-resistant layer, and both the inner flame-resistant layer and the outer flame-resistant layer have insulating properties; the inner flame-resistant layer covers an inner surface of the heater; and the outer flame-resistant layer covers an outer surface of the heater.

5. The coating material structure according to claim 4, wherein the outer layer further comprises: a thermal insulating layer, a glue layer, and an outer skin, the thermal insulting layer covers the outer flame-resistant layer, and the glue layer connects the thermal insulating layer and the outer skin.

6. The coating material structure according to claim 3, wherein the inner flame-resistant layer is made of polyimide (PI).

7. The coating material structure according to claim 5, wherein the inner flame-resistant layer and the outer flame-resistant layer are made of polyimide (PI).

8. The coating material structure according to claim 6, wherein the packaging main body is formed into a tubular shape.

9. The coating material structure according to claim 6, wherein the outer insulating layer and the thermal insulating layer are made of foamed silicon.

10. The coating material structure according to claim 6, wherein the heater has a coil performs heating by induction.
